(19) United States
(12) Patent Application Publication
(10) Pub. No.: US 2023/0114345 A1
(43) Pub. Date: Apr. 13, 2023

(54) MATERIAL SELECTION OF SUSTAINABLE CONTENT FOR AN INFORMATION HANDLING SYSTEM

(71) Applicant: Dell Products L.P., Round Rock, TX (US)

(72) Inventors: Deeder M. Aurongzeb, Austin, TX (US); Kin Hua Tian, Shanghai (CN); Hin Loong Wong, Singapore (SG)

(73) Assignee: Dell Products L.P., Round Rock, TX (US)

(21) Appl. No.: 17/450,442

(22) Filed: Oct. 8, 2021

(51) Int. Cl. G06Q 10/06

(52) U.S. Cl. CPC G06Q 10/06315

(57) ABSTRACT

A method for selecting sustainable materials for components of the information handling system can improve sustainability in a cost-effective manner. The method may analyze and determine component configurations with a goal of increasing (e.g., maximizing) overall sustainable material weight contribution by the respective product category and decreasing (e.g., minimizing) cost impact to overall company revenue and/or margin. In determining component configurations, the method may consider parameters including baseline weight, bill of materials (BOM) of the product, sustainable materials attainable, sustainable materials weightage, and/or program decision.

### FIELD OF THE DISCLOSURE

The instant disclosure relates to information handling systems. More specifically, portions of this disclosure relate to assembling information handling systems with sustainable materials.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The increase in the number of information handling systems used by consumers, and the pace at which new models are introduced creates a situation where many consumers replace electronic device components on a frequent basis. Many of these components are discarded as waste, end up in landfills, and remain buried in our planet for hundreds of years, if not longer. This “e-waste” is becoming considerable threat to planet with over 4% growth rate every year.

### SUMMARY

To reduce consumer trash and carbon emissions, companies can increase the use of sustainable materials in information handling systems. Sustainable materials can include both recycled and renewable materials. Sustainable materials (e.g., plastics, metal, etc.) refers to those that have been collected and processed into new products, rather than being thrown away as trash. However, there are added costs to the use of recycled materials over virgin materials. A method for selecting sustainable materials for components of the information handling system can improve sustainability in a cost-effective manner. The method may analyze and determine component configurations with a goal of increasing (e.g., maximizing) overall sustainable material weight contribution by the respective product category and decreasing (e.g., minimizing) cost impact to overall company revenue and/or margin. In determining component configurations, the method may consider parameters including baseline weight, bill of materials (BOM) of the product, sustainable materials attainable, sustainable materials weightage, and/or program decision. Baseline weight may refer to the total weight of all products that a company ships out in a certain period (e.g., a calendar or fiscal year).

After determining sustainable content amounts for each component of an information handling system, lines of businesses for manufacturing those components can be configured to produce the components with the determined sustainable content amounts. The determined sustainable content amounts may be incorporated into a contract for each line of business. The determined sustainable content amounts may also or alternatively be transmitted to a manufacturing entity for each of the lines of businesses. The components may be manufactured by each of the lines of businesses according to the contract or other instruction generated in accordance with the determined sustainable content amounts. The components may then be assembled into information handling systems. The resulting production of information handling systems may reach a target sustainable content amount for the overall manufacturing of information handling systems. The components and lines of businesses may be used in manufacturing multiple lines of information handling systems. The target sustainable content amount may correspond to a percentage of sustainable content over the entire volume of units of the multiple lines of information handling systems.

The determination of sustainable content for each line of business involved in the assembly of information handling systems can improve the amount of sustainable content used in the information handling systems without increasing the cost beyond an acceptable level of any line of business involved in the generation of components for the information handling systems. One benefit of the determination is to assist operations in reaching target sustainable content, which increases the ability for companies to increase the sustainable content amounts in their components and information handling systems, and meet their sustainable content targets. The benefits obtained from the assembly of information handling systems to include more sustainable content according to methods described herein improve the functioning of the information handling system by, for example, being more environmental friendly.

According to one embodiment, a method may include receiving, by an information handling system, a listing of lines of businesses that generate components for assembling information handling systems; receiving, by the information handling system, a listing of relative weights corresponding to the lines of businesses; receiving, by the information handling system, a listing of cost factors for increasing sustainable content corresponding to the lines of businesses; receiving, by the information handling system, one or more input parameters corresponding to assembling information handling systems, the one or more input parameters comprising a target sustainable content for assembling information handling systems; and/or determining, by the information handling system, a sustainable content amount for each of the lines of businesses based on the one or more input parameters, the listing of cost factors, and the listing of relative weights.

In certain embodiments, determining the sustainable content amount for each of the lines of businesses comprises weighting a distribution of the target sustainable content between each of the lines of businesses in the listing of lines of businesses based on the relative weights corresponding to the lines of businesses and the cost factors corresponding to the lines of businesses.

In certain embodiments, determining the sustainable content amount for each of the lines of businesses comprises: determining a set of the lines of businesses that have no capability of incorporating sustainable content; and/or weighting a distribution of the target sustainable content between each of the lines of businesses not in the set of lines of businesses that have no capability of incorporating sustainable content.

In certain embodiments, the listing of lines of businesses comprises at least a keyboard line, a mouse line, a storage line, a stand line, a monitor line, and a chassis line.

In certain embodiments, the listing of cost factors comprises for each of the lines of businesses an indication of a cost of increasing sustainable content for the each of the lines of businesses.

In certain embodiments, the listing of cost factors comprises a margin for the line of business, and wherein the determining the sustainable content amount for each of the lines of businesses comprises weighting a distribution of the target sustainable content between each of the lines of businesses such that no cost for a line of business increases beyond the margin for the line of business.

In certain embodiments, receiving the listing of relative weights comprises receiving a volume of units shipped for each of the lines of businesses.

In certain embodiments, the method may further include transmitting an order for a line of business based on the sustainable content amount determined for the line of business; and/or assembling an information handling system using components generated by the lines of businesses, each of the components having the sustainable content amount determined for a corresponding one of the lines of businesses.

The method may be embedded in a computer-readable medium as computer program code comprising instructions that cause a processor to perform operations corresponding to the steps of the method. In some embodiments, the processor may be part of an information handling system including a first network adaptor configured to transmit data, such as orders for lines of businesses over a first network connection; and a processor coupled to the first network adaptor, and the memory, wherein the processor is configured to perform operations corresponding to the steps of the method.

As used herein, sustainable materials include recycled content and/or renewable content as described below. Sustainable material content, or sustainable content, refers to a wt. % of a material obtained from or made from a recycled and/or renewable material.

As used herein, recycled content of a material refers to wt. % of the material obtained from, made from and/or recovered from waste. Unless mentioned otherwise the waste can be post-industrial and post-consumer waste. Post-consumer waste of a material is a waste generated by a customer of a substrate containing the material. Post-industrial waste is waste generated during a production process of a product and has not used in the consumer market.

As used herein, renewable content of a material refers to wt. % of the material obtained from or made from a bio-based renewable material. Unless mentioned otherwise, bio-based material can include materials from any life form such as plants, animals, fungi, protists, prokaryotes, microbes, algae, bacteria, yeasts and/or molds. The bio-based material can be obtained from natural or genetically engineered species.

As used herein total recycled and renewable content (e.g., a sustainable material content) of a material refers to wt. % of the material obtained from, made from and/or recovered from waste and wt. % of the material obtained from or made from a bio-based renewable material. For example, for a 100 gm material is 10 gm is obtained recycled sourced and 10 gm is obtained from renewable source, the total recycled and renewable content of the material is 20 wt. %.

As used herein, the term “coupled” means connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially parallel includes parallel), as understood by a person of ordinary skill in the art.

The phrase “and/or” means “and” or “or”. To illustrate, A, B, and/or C includes: A alone, B alone, C alone, a combination of A and B, a combination of A and C, a combination of B and C, or a combination of A, B, and C. In other words, “and/or” operates as an inclusive or.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus or system that “comprises,” “has,” or “includes” one or more elements possesses those one or more elements, but is not limited to possessing only those elements. Likewise, a method that “comprises,” “has,” or “includes,” one or more steps possesses those one or more steps, but is not limited to possessing only those one or more steps.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed system and methods, reference is now made to the following descriptions taken in conjunction with the accompanying drawings.

FIG. 1 is an exploded view of an information handling system according to some embodiments of the disclosure.

FIG. 2 is a block diagram illustrating a process for determining sustainable content amounts for information handling system components according to some embodiments of the disclosure.

FIG. 3 is a method for manufacturing information handling systems with improved sustainable content amounts according to some embodiments of the disclosure.

FIG. 4 is an example listing of lines of businesses with their associated weights in the total weight of information handling systems according to some embodiments of the disclosure.

### DETAILED DESCRIPTION

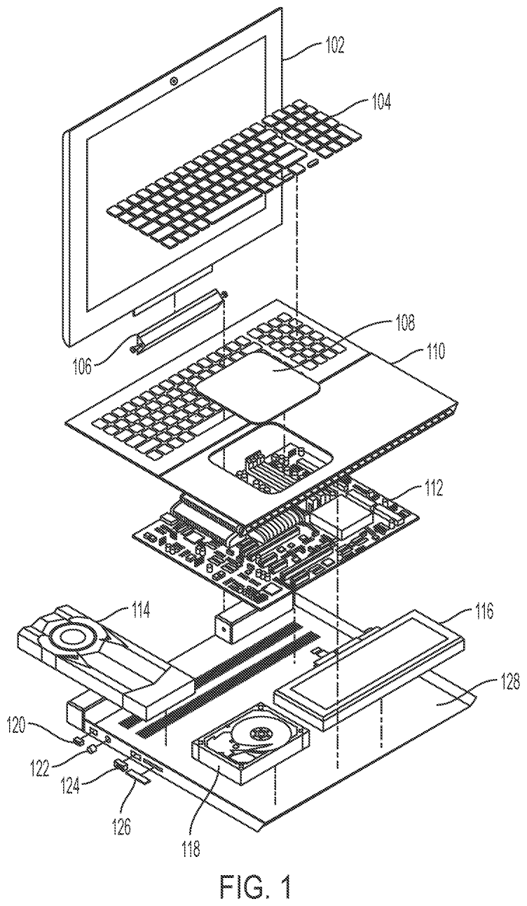

FIG. 1 is an exploded view of an information handling system according to some embodiments of the disclosure. An information handling system 100 may include components that are electrically and/or mechanically coupled together. Each of the components are conventionally manufactured from virgin metal or virgin plastics. However, such conventional components are not environmentally friendly. Some of the components may be determined to be manufactured using sustainable materials to reduce the environmental harm in manufacturing the information handling system 100 and/or discarding the information handling system 100. The components may include, for example, a screen 102, keyboard 104, hinge 106, touchpad 108, palm rest cover 110, motherboard 112, graphics card 114, battery 116, storage device 118, security slot 120, power connector 122, USB connector 124, card reader 126, and chassis 128. Each of the components may be made of a certain percentage of sustainable materials as indicated in FIG. 1, and each of those percentages determined in a manner that achieves a target sustainable content amount across the information handling system 100 while accounting for the unique costs associated with each of the components. The components may be manufactured in lines of businesses that may be separate from the business of assembling the components into the information handling system 100. For example, the components may be manufactured in lines of businesses corresponding to vendors or suppliers of the components for the information handling system. The assembler of the information handling system may determine the sustainable content amounts for the components and transmit the amounts to the lines of businesses, such as in the form of contracts for the components. The assembler may assemble the components into information handling systems.

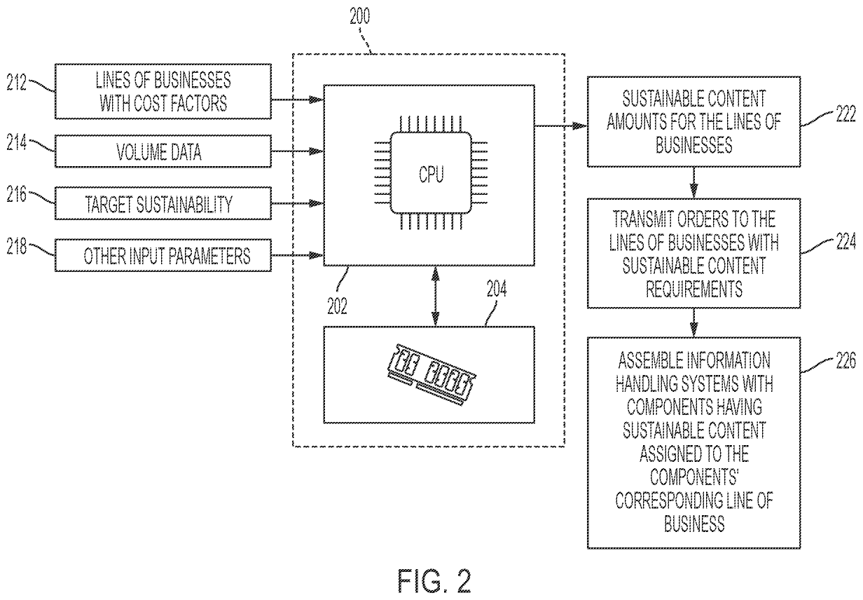

One embodiment for the determination of sustainable contents for the lines of businesses is shown in FIG. 2. FIG. 2 is a block diagram illustrating a process for determining sustainable content amounts for information handling system components according to some embodiments of the disclosure. A system 200 includes a processor 202 coupled to a memory 204. The processor 202 may store data in the memory 204 and/or retrieve data from the memory 204. The processor 202 may receive input, including a listing 212 of lines of businesses, a listing 214 of volume data corresponding to the lines of businesses, an input parameter 216, such as a target sustainability amount, and/or other input parameters 218. The listing of lines of businesses 212 may include lines of businesses corresponding to the components used in assembly of an information handling system, such as system 100 of FIG. 1. For example, lines of businesses may include one or more of a keyboard line, a mouse line, a storage line, a stand line, a monitor line, and a chassis line. The listing 212 may also include cost factors associated with each of the lines of businesses. The cost factors may include, for example, a profit margin associated with the component manufactured by each line of business. The cost factors may also or alternatively include, for example, an indication of how the cost of the component increases relative to increasing sustainable content amount and/or decreases relative to decreasing sustainable content amount. In some embodiments, the cost factor for a line of business may include a table listing per-component cost at various levels of sustainable material content. In some embodiments, the cost factor for a line of business may include an equation representing a relationship between the per-component cost and various levels of sustainable material content.

The listing 214 of volume data may include a number of components used from each of the lines of businesses, such as a number of each of the components used in assembling a line of information handling systems or multiple lines of handling systems. The listing 214 of volume data may be used as relative weights for determining a total amount of sustainable content used in assembled information handling systems. For example, the relative weight assigned to one line of business may be determined as a ratio of the volume data for that line of business to the summation of volume data in the listing 216. The relative weights may also or alternatively be based on a weight of each of the components relative to a weight of the completed information handling system. The target sustainability input parameter 216 may indicate a desired amount of sustainable material across assemble of a line of information handling systems or several lines of information handling systems. For example, the target sustainability input parameter 216 may be received from a user indicating 50% sustainable content for an information handling system or 50% sustainable content across several lines of information handling systems incorporating the components. Other input parameters 218 may also be received and used in determinations by the processor 202. The processor 202 may receive the inputs 212, 214, 216, and/or 218 through one or a combination of user input to a graphical user interface (GUI), an input configuration file, and/or remote data entry (such as through a web page or web application hosted by the processor 202). The processor 202 may store the inputs 212, 214, 216, and/or 218 in the memory 204, and retrieve the inputs 212, 214, 216, and/or 218 from the memory 204 for performing determinations, such as a determination of sustainable content amounts.

The processor 202 may execute an algorithm for determining sustainable content amounts 222 for each of the lines of businesses in the listing 212. Those sustainable content amounts 222 may be stored in memory 204. The processor 202 may perform operations using the sustainable content amounts 222. For example, the processor 202 may generate and transmit orders 224 for components from the lines of businesses in listing 212 specifying the lines of businesses to generate components with sustainable content levels corresponding to the sustainable content amounts 222. The orders may be fulfilled by the lines of businesses and components used to assemble 226 information handling systems. The information handling systems have an improved amount of sustainable content based on the determination of the sustainable content amounts 222.

The sustainable content amounts 222 may be determined by weighting a distribution of the target sustainable content between each of the lines of businesses in the listing of lines of businesses based on the relative weights corresponding to the lines of businesses and the cost factors corresponding to the lines of businesses. For example, an optimization algorithm may be executed to identify a distribution of sustainable content among the various components for the lines of businesses that minimizes, or otherwise reduces, the cost of the information handling system assembled from the various components.

In some embodiments, the determination of the sustainable content amounts 222 may include determining a set of the lines of businesses that have no capability of incorporating sustainable content. This set may include lines of businesses for which the cost is too high or for which sustainable materials are not available. The sustainable content amounts for lines of businesses in this set may be set to zero. The weighting of sustainable content amounts may distribute the target sustainable content between each of the lines of businesses not in the set of lines of businesses that have no capability of incorporating sustainable content. For example, if certain components do not have options for incorporating sustainable material, other lines of businesses may need o include higher sustainable content amounts such that the overall target sustainability level 216 is satisfied for the assembly of information handling system.

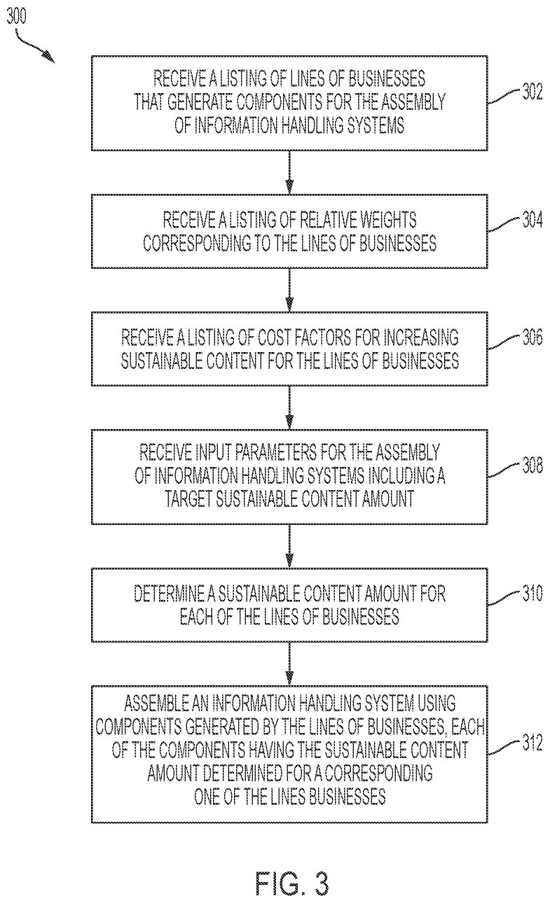

FIG. 3 is a method 300 for manufacturing information handling systems with improved sustainable content amounts according to some embodiments of the disclosure. At block 302, a listing is received of lines of businesses that generate components for the assembly of information handling systems. At block 304, a listing is received of relative weights (e.g., volume amounts) corresponding to the lines of businesses. At block 306, a listing is received of cost factors for increasing sustainable content for the lines of businesses. At block 308, one or more input parameters are received for the assembly of the information handling systems, the input parameters including a target sustainable content amount (e.g., a weight percentage of sustainable content for the information handling systems). At block 310, a sustainable content amount is determined for each of the lines of businesses at block 302. The determination may include executing an optimization algorithm using the inputs received at blocks 302, 304, 306, and 308 to arrive at a sustainable content amount for each of the lines of businesses. The optimization may be performed using an iterative method, linear method, non-linear method, gradient descent method, local search method, line search method, ellipsoid method, combinatorial optimization algorithm, branch and bound method, or other optimization method. In some embodiments, a machine learning algorithm may be used to learn the cost factors associated with each line of business and determine sustainable content amounts for those lines of businesses based on a desired target sustainable content amount. At block 312, an information handling system may be assembled using components from the lines of businesses in the listing received at block 302 according to the determined sustainable content amounts of block 310.

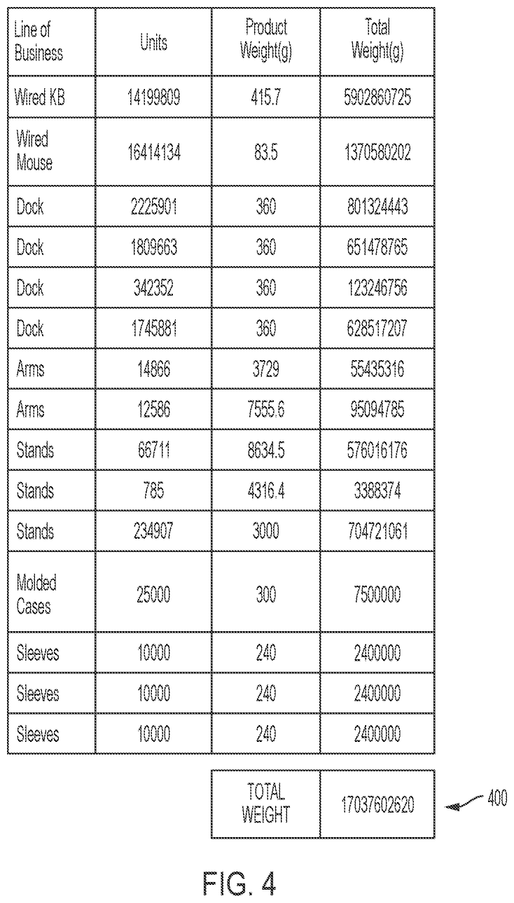

The determination of sustainable content for the lines of businesses involved in manufacturing information handling systems may optimize sustainable content in individual components to reach a target sustainable content amount for the systems overall. In determining the amounts for individual components, each component may be weighted based on the component's contribution to the total weight of the manufactured information handling systems. FIG. 4 is an example listing of lines of businesses with their associated weights in the total weight of information handling systems according to some embodiments of the disclosure. Each row in the column corresponds to a different line of business (e.g., a dock component, a stand component, a mouse component). The first data column corresponds to the number of units from each line of business used during a time period (e.g., a calendar or fiscal year) in the manufacturing of information handling systems. The second data column corresponds to the product weight of an individual component. The third data column corresponds to the total weight of the individual component used during the time period. A total weight 400 of consumed materials is a sum of the total weight for each line of business involved in the manufacturing of information handling systems during the time period.

Some materials used in each of the lines of businesses can be substituted with sustainable content. However, some materials do not have sustainable substitutes. Some reasons for having no sustainable options include: PCR ABS is readily available; renewable nylon to use as PCR nylon is not easily available due to low recycling volumes; clear PCR PC may not be as easily available, as there could be impurities in the material if meant for usage in external cosmetic part or light transmission part; and/or some product category can be subject to contractual restrictions such that sustainable materials cannot be substituted. Some example sustainable content that can be used in components includes: WAM 35% PCR ABS (e.g., 35% recycled ABS with 65% virgin ABS from WAM); Kingfa 85% PCR ABS (e.g., 85% recycled ABS with 15% virgin ABS from Kingfa); RTP 50% Nylon (e.g., 50% renewable Nylon with 50% virgin Nylon from RTP).

The substitution of sustainable content for materials in the components can change the characteristics of the components. For example, a higher percentage of sustainable content may result in lower material engineering grade (e.g., lower yield tensile strength by approximately 10-20% or more). In some embodiments, the other input parameters (e.g., other input parameters 218 of FIG. 2) may be input to a processor and used in determining the sustainable content amounts for lines of businesses. For example, known changes in material characteristics may be used to limit an amount of sustainable content assigned to a particular line of business based on target material parameters. For example, a target tensile strength value or range for a component from a line of business may be set, and the sustainable content amount for that line of business is not set high enough to reduce the tensile strength of the material below the target tensile strength.

In various embodiments, the determination of sustainable content amounts can consider how much sustainable material that can be implemented in a product category corresponding to a line of business. The factors may include volume of units shipped, weight of unit of individual components, and/or percent sustainable material attainable. By comparing the sustainable material weight of a product category against a total weight of products (in a product, a line of product, multiple lines of products, or across a company), a contributing factor of sustainable material by that product category to operations across a product, products, or company. This number can be used to determine a sustainable materials weightage (or contribution) as a fraction of a company's total weight of products from this equation:

$$\frac{\begin{matrix}Volume of Units Shipped \times Weight of Unit \times \\ \% Sustainable Material Attainable\end{matrix}}{Total Weight of Products}$$

In some embodiments, components and/or certain lines of businesses can be categorized and prioritized as part of determining a sustainable content amount for the lines of businesses. For example, lines of businesses may be grouped by line of businesses' contribution to the overall total weight. For example, a first group of lines of businesses with weight contribution of >=5% may be identified, a second group of lines of businesses with weight contribution of between 2 and 5% may be identified, and a third group of lines of businesses with weight contribution of between 0 and 2% may be identified. The groups may be prioritized for increasing sustainable content amounts when determining sustainable content amounts for each of the lines of businesses. For example, the first group of lines of businesses may be weighted heavier when assigning sustainable content amounts to the lines of businesses to reach a target sustainable content amount because increases in these lines of businesses have the greatest effect on overall sustainable content amount in an assembled information handling system.

These example embodiments describe and illustrate various methods of determining sustainable content amounts for components of an information handling system and assembling information handling systems to achieve a target sustainable content. However, the application of determinations, methods, and techniques described herein are not limited to the assembly of information handling systems. The determinations, methods, and techniques may be applied to other consumer devices, appliances, and/or other goods to cost-effectively improve the amount of sustainable content in such goods.

The schematic flow chart diagrams of FIG. 2 and FIG. 3 is generally set forth as a logical flow chart diagram. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method, comprising:
receiving, by an information handling system, a listing of lines of businesses that generate components for assembling information handling systems;
receiving, by the information handling system, a listing of relative weights corresponding to the lines of businesses;
receiving, by the information handling system, a listing of cost factors for increasing sustainable content corresponding to the lines of businesses;
receiving, by the information handling system, one or more input parameters corresponding to assembling information handling systems, the one or more input parameters comprising a target sustainable content for assembling information handling systems; and
determining, by the information handling system, a sustainable content amount for each of the lines of businesses based on the one or more input parameters, the listing of cost factors, and the listing of relative weights.

2. The method of claim 1, wherein determining the sustainable content amount for each of the lines of businesses comprises:
weighting a distribution of the target sustainable content between each of the lines of businesses in the listing of lines of businesses based on the relative weights corresponding to the lines of businesses and the cost factors corresponding to the lines of businesses.

3. The method of claim 1, wherein determining the sustainable content amount for each of the lines of businesses comprises:
determining a set of the lines of businesses that have no capability of incorporating sustainable content; and
weighting a distribution of the target sustainable content between each of the lines of businesses not in the set of lines of businesses that have no capability of incorporating sustainable content.

4. The method of claim 1, wherein the listing of lines of businesses comprises at least a keyboard line, a mouse line, a storage line, a stand line, a monitor line, and a chassis line.

5. The method of claim 1, wherein the listing of cost factors comprises for each of the lines of businesses an indication of a cost of increasing sustainable content for the each of the lines of businesses.

6. The method of claim 1, wherein the listing of cost factors comprises a margin for the line of business, and wherein the determining the sustainable content amount for each of the lines of businesses comprises weighting a distribution of the target sustainable content between each of the lines of businesses such that no cost for a line of business increases beyond the margin for the line of business.

7. The method of claim 1, wherein receiving the listing of relative weights comprises receiving a volume of units shipped for each of the lines of businesses.

8. The method of claim 1, further comprising assembling an information handling system using components generated by the lines of businesses, each of the components having the sustainable content amount determined for a corresponding one of the lines of businesses.

9. A computer program product, comprising:
a non-transitory computer readable medium comprising code for performing steps comprising:
receiving, by an information handling system, a listing of lines of businesses that generate components for assembling information handling systems;
receiving, by the information handling system, a listing of relative weights corresponding to the lines of businesses;
receiving, by the information handling system, a listing of cost factors for increasing sustainable content corresponding to the lines of businesses;
receiving, by the information handling system, one or more input parameters corresponding to assembling information handling systems, the one or more input parameters comprising a target sustainable content for assembling information handling systems; and
determining, by the information handling system, a sustainable content amount for each of the lines of businesses based on the one or more input parameters, the listing of cost factors, and the listing of relative weights.

10. The computer program product of claim 9, wherein determining the sustainable content amount for each of the lines of businesses comprises:
weighting a distribution of the target sustainable content between each of the lines of businesses in the listing of lines of businesses based on the relative weights corresponding to the lines of businesses and the cost factors corresponding to the lines of businesses.

11. The computer program product of claim 9, wherein determining the sustainable content amount for each of the lines of businesses comprises:
determining a set of the lines of businesses that have no capability of incorporating sustainable content; and
weighting a distribution of the target sustainable content between each of the lines of businesses not in the set of lines of businesses that have no capability of incorporating sustainable content.

12. The computer program product of claim 9, wherein the listing of lines of businesses comprises at least a keyboard line, a mouse line, a storage line, a stand line, a monitor line, and a chassis line.

13. The computer program product of claim 9, wherein the listing of cost factors comprises for each of the lines of businesses an indication of a cost of increasing sustainable content for the each of the lines of businesses.

14. The computer program product of claim 9, wherein the listing of cost factors comprises a margin for the line of business, and wherein the determining the sustainable content amount for each of the lines of businesses comprises weighting a distribution of the target sustainable content between each of the lines of businesses such that no cost for a line of business increases beyond the margin for the line of business.

15. The computer program product of claim 9, wherein receiving the listing of relative weights comprises receiving a volume of units shipped for each of the lines of businesses.

16. The computer program product of claim 9, wherein the medium further comprises code for performing steps comprising transmitting an order for a line of business based on the sustainable content amount determined for the line of business.

17. An apparatus, comprising:
a memory;
a processor coupled to the memory, wherein the processor is configured to perform steps comprising:
receiving, by an information handling system, a listing of lines of businesses that generate components for assembling information handling systems;
receiving, by the information handling system, a listing of relative weights corresponding to the lines of businesses;
receiving, by the information handling system, a listing of cost factors for increasing sustainable content corresponding to the lines of businesses;
receiving, by the information handling system, one or more input parameters corresponding to assembling information handling systems, the one or more input parameters comprising a target sustainable content for assembling information handling systems; and
determining, by the information handling system, a sustainable content amount for each of the lines of businesses based on the one or more input parameters, the listing of cost factors, and the listing of relative weights.

18. The information handling system of claim 17, wherein determining the sustainable content amount for each of the lines of businesses comprises:
weighting a distribution of the target sustainable content between each of the lines of businesses in the listing of lines of businesses based on the relative weights corresponding to the lines of businesses and the cost factors corresponding to the lines of businesses.

19. The information handling system of claim 17, wherein determining the sustainable content amount for each of the lines of businesses comprises:
determining a set of the lines of businesses that have no capability of incorporating sustainable content; and
weighting a distribution of the target sustainable content between each of the lines of businesses not in the set of lines of businesses that have no capability of incorporating sustainable content.

20. The information handling system of claim 17, wherein the listing of cost factors comprises a margin for the line of business, and wherein the determining the sustainable content amount for each of the lines of businesses comprises weighting a distribution of the target sustainable content between each of the lines of businesses such that no cost for a line of business increases beyond the margin for the line of business.
